(19) United States
(12) Patent Application Publication
(10) Pub. No.: US 2007/0288938 A1
(43) Pub. Date: Dec. 13, 2007

(54) Sharing data between partitions in a partitionable system

(76) Inventors: Daniel Zilavy, Fort Collins, CO (US); John A. Morrison, Fort Collins, CO (US); Russ W. Herrell, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/451,260

(22) Filed: Jun. 12, 2006

(51) Int. Cl. G06F 13/00

(52) U.S. Cl. 719/327

(57) ABSTRACT

A system for sharing data between partitions is provided. The system comprises a plurality of partitions and a storage accessible to the plurality of partitions. Each partition comprises an inter-partition data sharing logic comprising one or more registers that receive data packets for sharing between partitions, and a connection to a system fabric operably coupling the inter- partition data sharing logic to the storage. The system fabric couples the partitions, through the storage, to one another instead of use of a network connection. Alternatively, a management subsystem may also be used to couple the partitions to one another instead of use of a network connection.

### BACKGROUND

As computer system processing capacity increases, partitionable computer systems have emerged as a desirable solution providing flexibility and security. In a partitionable computer system, the computer's resources are “carved” into a plurality of environments, each isolated from the others. Each partition, for example, may be configured to support a particular operating system and applications supported by the operating system. By dividing the computer's resources into a plurality of partitions, a greater degree of flexibility is attained since different operating systems and applications can operate on different partitions. At the same time, each partition is protected in the event that another partition is corrupted or fails. The isolation between partitions which results in flexibility and ensures robust security, however, makes useful communication between the partitions difficult.

### BRIEF DESCRIPTION OF THE DRAWINGS

For a detailed description of exemplary embodiments of the invention, reference will now be made to the accompanying drawings in which:

FIG. 1 shows a block diagram of a partitionable computer system in accordance with various embodiments of the present disclosure;

FIG. 2 shows a block diagram of an inter-partition data sharing logic in a partition in accordance with various embodiments of the present disclosure; and

FIG. 3 shows a flowchart for a method of sharing data between partitions in a partitionable computer system in accordance with various embodiments of the present disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present disclosure enables sharing of data between two or more partitions in a partitionable computer system without requiring network cabling to connect the partitions and without requiring modification of the operating system (“O/S”), the network stack, and applications of each partition. By implementing inter-partition data sharing logic, which in some embodiments may be referred to as a virtual Network Interface Controller (“vNIC”), sharing of data between two or more partitions may be accomplished in a manner that, to each partition, appears to function just as if a standard Network Interface Controller (“NIC”) were in place to transfer data via an Internet connection. Using the inter-partition data sharing logic of the present disclosure, drivers used with NICs for the particular O/S running on the partition (including existing and future developed standard or customized drivers) may accomplish the sharing of data across partitions without network cabling. By using drivers for the particular O/S in this manner, modification of the O/S may be avoided, at least for purposes of enabling data sharing between partitions.

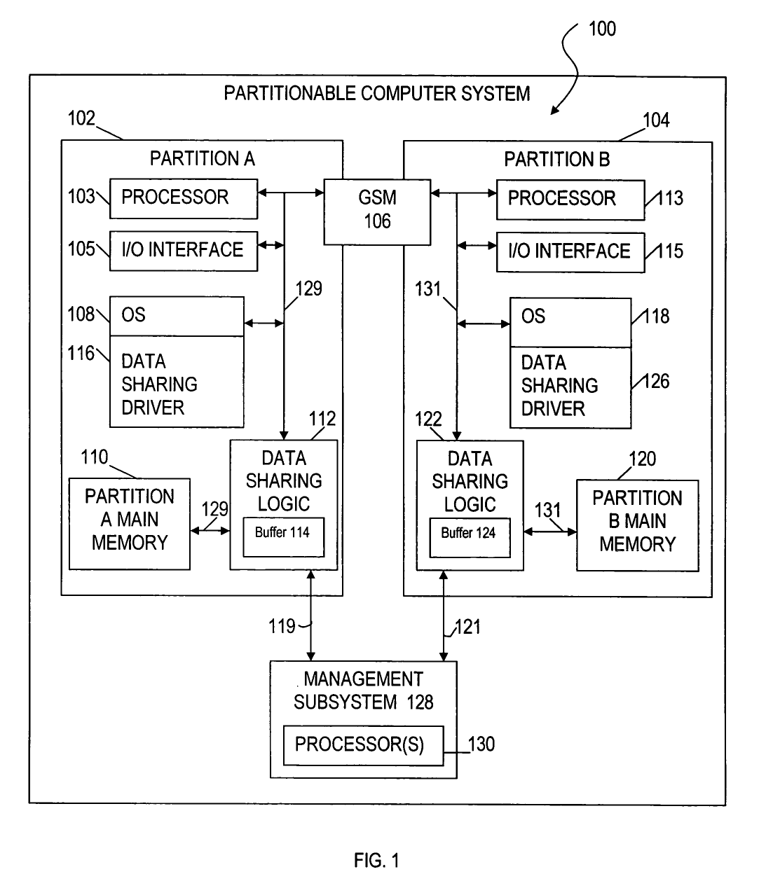

Referring now to FIG. 1, at least two partitions (here, illustrated as Partition A 102 and Partition B 104) are defined within a partitionable computer system 100. System 100 may be a server or other type of computer. In various embodiments, a firewall (not shown) is implemented to isolate the partitions. The degree of isolation between partitions may depend upon whether the partitions are, for example, “soft” partitions or “hard” partitions. Both “soft” and “hard” partitions support moving processor, memory and input/output resources between partitions, depending on physical limitations. Soft partitions allow community memory. Hard partitions generally restrict fault propagation across partitions, while soft partitions do not. Soft partitions are subject to greater risk that an errant operating system operating on one partition will take down the other partitions, while hard partitions are more resistant to this occurrence. This disclosure is not limited to any particular type of partitioning.

As shown in FIG. 1, partition A 102 comprises an O/S 108, a partition A main memory 110, an inter-partition data sharing logic 112, and a data sharing driver 116 (which is a driver, existing or to be developed, standard to or customized for the O/S 108). The partition A main memory 110 may be volatile storage (e.g., RAM) and/or non-volatile storage (e.g., ROM, FRAM, Flash, hard drive, etc.). The inter-partition data sharing logic 112 of Partition A 102 comprises a memory buffer 114 in the embodiment shown in FIG. 1. Partition B 104 similarly comprises an O/S 118, a partition B main memory 120, an inter-partition data sharing logic 122, and a data sharing driver 126 (which comprises a driver, existing or developed in the future, standard or customized for the O/S 118). The partition B main memory 120 may be volatile memory (e.g., RAM) and/or non-volatile memory (e.g., ROM, FRAM, Flash, hard drive, etc.). The inter-partition data sharing logic 122 of Partition B 104 also comprises a memory buffer 124 in the embodiment shown in FIG. 1.

Each partition 102, 104 comprises one or more processors 103, 113 and an input/output interface 105, 115. Each processor executes one or more applications and one or more operating systems, such as O/Ss 108 and 118 respectively. The applications and O/S may be stored in partition main memory 110 and 120 to be executed in each respective partition. Tasks carried out in execution of the applications and O/S may have occasion to pass data between the various partitions. For example, partition 102 may operate on O/S 108 to serve as a database backend. Partition 104 within the same partitionable computer system 100 may operate on O/S 118 to function as a web server to which users or clients may connect and access the database. In this example, the web server and database backend reside in different partitions, and have occasion to share data. The operating systems on the partitions may be of different types (e.g., LINUX™, WINDOWS™, etc.), different versions of the same O/S, or they may be different instances of the same operating system.

The partitions 102, 104 have access to a common Global Shared Memory (“GSM”) 106. The Global Shared Memory 106 is a shared memory to which multiple partitions in the partitionable system 100 may be mapped (i.e., a storage accessible by each partition in the partitionable system 100). For example, in various embodiments, the GSM 106 may be written to by partition A 102, and read from by partition B 104, and vice versa. The GSM 106 may comprise shared storage as well as “mailbox” space for messaging between inter-partition data sharing logics in the various partitions. The system fabric 129, 131 (to be discussed in greater detail below) connects the GSM 106 to each of the inter-partition data sharing logics 112, 122, respectively.

FIG. 1 also shows a management subsystem 128. The management subsystem couples to the partitions 102, 104 and manages the transfer of information between the inter-partition data sharing logics 112 and 122, meaning that a network connection is not used to pass data packets between the partitions. In various embodiments, the management subsystem 128 also manages information transfer between each inter-partition data sharing logic 112, 122 and the GSM 106. In various embodiments, the management subsystem 128 comprises one or more processors 130 that execute firmware independent of the O/S running on any given partition.

The management subsystem 128 identifies how the partitionable computer system 100 is partitioned, for example, the number of partitions, what O/S each partition is running, whether the partitioning is “hard” or “soft” partitioning, and how resources are assigned according to the partitions. Other functions of the management subsystem 128 include any or all of monitoring system temperature, fan speed, electrical systems, power output, and other environmental aspects of the partitionable computer system 100. The management subsystem 128 couples the partitions 102, 104 by way of interconnects 119 and 121. Each of the interconnects 119, 121 comprise, for example, a serial bus or other type of data connection.

FIG. 1 also shows a system fabric in each partition (129 for Partition A 102 and 131 for Partition B). The system fabric 129, 131 is the physical “glue” between the processors of each partition and each of the device components in the partition, and provides the means by which the O/S 108, 118 communicates with each device and memory in the partition. The system fabric 129, 131 is an infrastructure of interconnecting high-speed serial busses that interconnects the processor running the O/S, the memory, the I/O interface, and the inter-partition data sharing logic. The system fabric 129 has connection points in common with the management subsystem 128, linking the two. The system fabric 129, 131 accomplishes communication between devices at higher performance bandwidths than the management subsystem 128. The system fabric for each partition is separated from the other system fabric by a firewall that isolates the partitions.

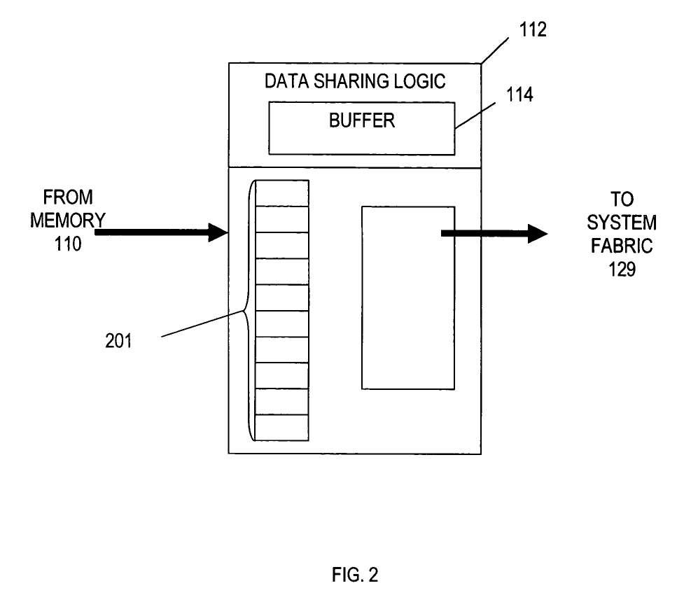

FIG. 2 shows a block diagram of inter-partition data sharing logic 112. The inter-partition data sharing logic 122 is configured similar or identical to inter-partition data sharing logic 112. Referring now to FIG. 2, the inter-partition data sharing logic 112 is the mechanism for sharing data between partitions. The inter-partition data sharing logic 112 comprises registers 201 that are the same as, or similar to, the registers of a NIC. Because the inter-partition data sharing logic 112 has the same, or at least similar, registers 201 as a NIC, inter-partition data sharing logic 112 may be written to, and read from, as if the inter-partition data sharing logic 112 were a NIC. Thus, from the perspective of the processor 103, the inter-partition data sharing logic 112 appears to be a NIC. For example, the network stack of the partition (the O/S's software implementation of networking protocol, not shown separately) writes to the registers 201 of the inter-partition data sharing logic 112. In various embodiments, each inter-partition data sharing logic 112, 122 comprises a Field Programmable Gate Array (“FPGA”) or plug-in card. Such a FPGA or plug-in card is programmed in such a way that, from the perspective of the O/S and network stack where data packets are written into the registers, the registers 201 appear to the O/S 108 the same as, or at least similar to, registers in a NIC. Such a FPGA or plug-in card is further programmed in such a way that, where in a NIC a connection to internet or a LAN would exist, the inter-partition data sharing logic 112, 122 connects in connections 129, 131 directly with the GSM 106 or directly with other inter-partition data sharing logics via the management subsystem 128.

Because the registers 201 of the inter-partition data sharing logics 112, 122 appear to the O/S as the same as those for a NIC, data sharing drivers 116, 126 that read to, and write from, a NIC may be used to read to, and write from, the inter-partition data sharing logics 112, 122. That is, any driver (off-the-shelf or customized drivers) that can operate a NIC can be used in embodiments of the present invention, even though a NIC is not used or necessarily even present. The data sharing driver is software that processes the particular way the inter-partition data sharing logic is accessed (i.e., how to send commands and/or data to the inter-partition data sharing logic). In various embodiments, the data sharing driver 116, 126 may be selected from various widely available drivers based upon which O/S 108, 118 is running on the partition 102, 104 or from customized drivers for the O/S.

In another embodiment, the memory buffers 114, 124 of inter-partition data sharing logics 112, 122 store data that may be buffered while in transit to or from another partition. As an alternative to the GSM 106, each memory buffer 114, 124 may serve as a storage location for data being shared between partitions 102, 104.

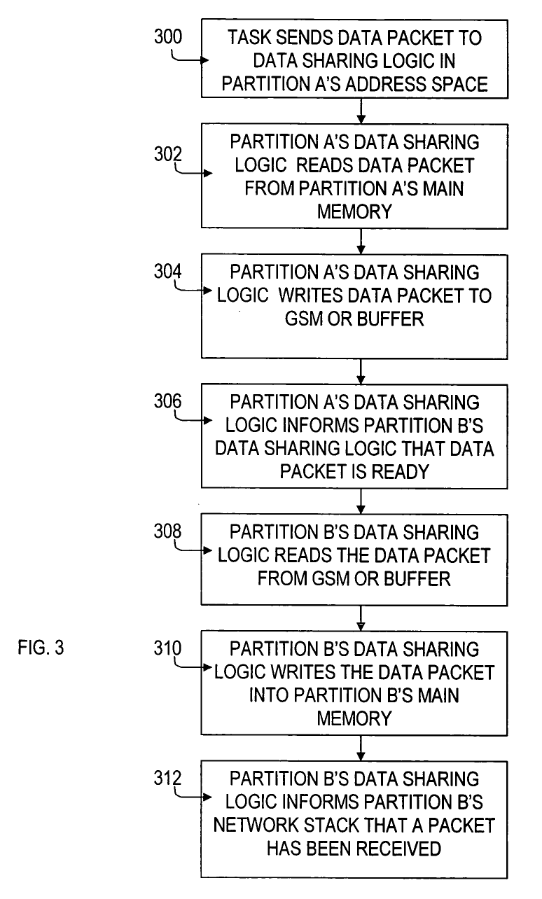

Referring now to FIG. 3, a flowchart is shown of an illustrative method of sharing data between partitions in a partitionable computer system in accordance with various embodiments. In the example of FIG. 3, a data packet is sent from partition A 102 to partition B 104. In block 300, an application executing in partition A 102 carries out a task that sends a data packet to its network stack with the end result of sending the packet to partition B 104, performing by sending the data packet to the inter-partition data sharing logic 112 in partition A 102. The network stack programs the inter-partition data sharing logic 112 using a stock NIC driver as the data sharing driver 116. In block 302, at the direction of its data sharing driver 116, the inter-partition data sharing logic 112 in partition A 102 reads the data packet used by the task from the partition A main memory 110. At the direction of its data sharing driver 116, the inter-partition data sharing logic 112 writes the data packet to the GSM 106 via the system fabric (block 304).

The inter-partition data sharing logic 112 in partition A 102 then messages inter-partition data sharing logic 122, via the management subsystem 128, in partition B 104 to inform the receiving partition (104) that a data packet has been transferred to the GSM 106 and is ready (block 306). Upon receiving the message, inter-partition data sharing logic 122 in partition B 104 reads the data packet from the GSM 106 via the system fabric (block 308). The inter-partition data sharing logic 122 then writes the data packet retrieved from storage into the partition B main memory 120 (block 310). With the shared data packet in partition B main memory 120, the inter-partition data sharing logic 122 notifies the network stack for Partition B 104 that the data packet has been received and may be used in a task executed in Partition B 104.

In an alternative embodiment method of FIG. 3, a data packet is sent from partition A 102 to partition B 104. In block 300, an application executing in partition A 102 carries out a task that sends a data packet to its network stack with the end result of sending the packet to partition B 104, by sending the data packet to the inter-partition data sharing logic 112 in partition A 102. The network stack programs the inter-partition data sharing logic 112 using a stock NIC driver as the data sharing driver 116. In block 302, at the direction of its data sharing driver 116, the inter-partition data sharing logic 112 in partition A 102 reads the data packet used by the task from the partition A main memory 110. At the direction of its data sharing driver 116, the inter-partition data sharing logic 112 writes the data packet to the buffer 114 (block 304). The data packet is then transferred, at the direction of the data sharing driver 116, from the buffer 114 to the buffer 124 via the management subsystem 128 (block 305).

The inter-partition data sharing logic 112 in partition A 102 then messages inter-partition data sharing logic 122, via the management subsystem 128, in partition B 104 to inform the receiving partition (104) that a data packet has been transferred to the buffer 124 and is ready (block 306). Upon receiving the message, inter-partition data sharing logic 122 in partition B 104 reads the data packet from the buffer 124 (block 308). The inter-partition data sharing logic 122 then writes the data packet retrieved from storage into the partition B main memory 120 (block 310). With the shared data packet in partition B main memory 120, the inter-partition data sharing logic 122 notifies the network stack for Partition B 104 that the data packet has been received and may be used in a task executed in Partition B 104.

The above discussion is meant to be illustrative of the principles and various embodiments of the present invention. Numerous variations and modifications will become apparent to those skilled in the art once the above disclosure is fully appreciated. For example, other forms of storage in addition to the GSM 106 and the buffers in the inter-partition data sharing logics are similarly sufficient to store data packets being shared between partitions. It is intended that the following claims be interpreted to embrace all such variations and modifications.

What is claimed is:

1. A system, comprising:
a plurality of partitions, each partition comprising an inter-partition data sharing logic comprising one or more registers that receive data packets for sharing between partitions;
a storage accessible to the plurality of partitions; and
a system fabric operably coupling each inter-partition data sharing logic to the storage, thereby enabling sharing of data between the partitions without a network connection.

2. The system of claim 1, further comprising an operating system that executes one or more tasks causing transfer of data packets between the partitions.

3. The system of claim 1, further comprising a management subsystem comprising one or more processors that interface between inter-partition data sharing logics and perform messaging functions; and each inter-partition data sharing logic further comprises a buffer operably coupling via the management subsystem to other inter-partition data sharing logics in other partitions.

4. The system of claim 1, wherein the management subsystem is operable to send messages from one partition to another when data is transferred to the storage from one partition to another.

5. The system of claim 2, wherein the management subsystem executes firmware independent of the operating system running on any of the partitions.

6. The system of claim 1, wherein the inter-partition data sharing logic of each partition is driven by a NIC driver for the operating system running on each partition.

7. An apparatus, comprising:
a storage accessible to a plurality of partitions;
one or more registers that receive data packets and send data packets to the storage; and
a connection to a system fabric interfacing between the registers and the storage, wherein the system fabric passes data packets from one partition to another through the storage;
wherein the storage stores data during transfer between partitions; and
wherein a network connection is not used to pass the data packets between the at least two partitions.

8. The apparatus of claim 7, further comprising a memory buffer additionally operable to store data during transfer between partitions.

9. The apparatus of claim 7, further comprising a connection to a management system comprising one or more microprocessors that interface between partitions for sharing data and messaging between partitions when data has been shared.

10. The apparatus of claim 7, wherein the one or more registers appear, from within each partition, as NIC registers so that NIC drivers may be used to drive operation of the apparatus.

11. A method, comprising:
connecting a first partition and a second partition in a partitionable system via a shared memory and a management subsystem;
executing a task in the first partition; wherein the task calls for transfer of a data packet from the first partition to the second partition; and
transferring the data packet from the first partition to the second partition via the shared memory accessible by both the first partition and the second partition;
wherein a network connection is not used to transfer the data packet from the first partition to the second partition.

12. The method of claim 11, wherein transferring the data packet further comprises storing the data packet in the storage during transfer of the data packet from the first partition to the second partition.

13. The method of claim 12, wherein transferring the data packet further comprises:
reading a data packet from a memory of the first partition;
writing the data packet to the storage via a first system fabric of the first partition;
informing the second partition via the management subsystem that the data packet is available in the storage;
reading the data packet from the storage via a second system fabric of the second partition; and
writing the data packet to a memory of the second partition.

14. The method of claim 12, wherein transferring the data packet further comprises:
reading a data packet from a memory of the first partition;
writing the data packet from a first buffer of the first partition to a second buffer of the second partition via the first and second system fabrics;
informing the second partition via the management subsystem that the data packet is available in the second buffer;
reading the data packet from the second buffer via the management subsystem; and
writing the data packet to a memory of the second partition.

15. The method of claim 13, wherein reading the data packet from the memory of the first partition comprises driving a first logic device of the first partition to read the data packet from the memory using a NIC driver for an operating system executing on the first partition.

16. The method of claim 13, wherein writing the data packet to the storage comprises driving the first logic device to write the data packet to the storage using a NIC driver for an operating system executing on the first partition.

17. The method of claim 13, wherein reading the data packet from the storage comprises driving a second logic device of the second partition to read the data packet from the storage using a NIC driver for an operating system executing on the second partition.

18. The method of claim 13, wherein writing the data packet to a memory of the second partition comprises driving the second logic device to write the data packet to a memory of the second partition using a NIC driver for an operating system executing on the second partition.

19. The method of claim 13, wherein informing the second partition that the data packet is available comprises sending a notification message via a mailbox in the storage.
